(19) United States
(12) Patent Application Publication
(10) Pub. No.: US 2015/0262537 A1
(43) Pub. Date: Sep. 17, 2015

(54) GAMMA VOLTAGE GENERATING APPARATUS AND METHOD FOR GENERATING GAMMA VOLTAGE

(71) Applicant: Novatek Microelectronics Corp., Hsinchu (TW)

(72) Inventor: Ju-Lin Huang, Hsinchu County (TW)

(73) Assignee: Novatek Microelectronics Corp., Hsinchu (TW)

(21) Appl. No.: 14/295,344

(22) Filed: Jun. 4, 2014

(30) Foreign Application Priority Data
Mar. 12, 2014 (TW) 103108687

(51) Int. Cl. G09G 3/36

(52) U.S. Cl. CPC G09G 3/3607; G09G 2310/027; G09G 2300/0828

(57) ABSTRACT

A gamma voltage generating apparatus and a method for generating a gamma voltage are provided. The gamma voltage generating apparatus includes a plurality of digital-to-analog converter units, a resister string and a plurality of selecting units. The digital-to-analog converter units generate a plurality of curve reference voltages. The resister string includes a plurality of resistors connected in series with each other to provide a plurality of endpoints. A part of the endpoints are set to be a plurality of curve turning intervals. Each of the selecting units respectively corresponds to each of the digital-to-analog converter units and each of the curve turning intervals. Each of the selecting units selectively provides each of the curve reference voltages to one of the endpoints of a corresponding of the curve turning intervals.

### CROSS-REFERENCE TO RELATED APPLICATION

This application claims the priority benefit of Taiwan application serial no. 103108687, filed on Mar. 12, 2014. The entirety of the above-mentioned patent application is hereby incorporated by reference herein and made a part of this specification.

### BACKGROUND OF THE INVENTION

1. Field of the Invention

The invention relates to a gamma voltage generating apparatus configured for a display apparatus, and particularly relates to a gamma voltage generating apparatus and a method for generating a gamma voltage capable of providing a plurality of gamma curves based on a user's requirement.

2. Description of Related Art

The advanced opto-electronic and semiconductor technology brings about the prosperous development of flat panel displays. Flat panel displays include displays of several different technologies, among which the liquid crystal display (LCD) has become the mainstream on the market for its characteristics such as high space utilization, low power consumption, absence of radiation, and low electromagnetic interference.

In the framework of liquid crystal displays nowadays, a gamma voltage generating apparatus is required to be disposed externally for a source driver of a liquid crystal driver to generate a plurality of gamma voltages and control the liquid crystal display panel to display corresponding gray-scale values accordingly, thereby displaying high-quality images. Generally speaking, the gamma voltage generating apparatus inputs a plurality of reference voltages into a part of endpoints of a resistor series and generates a gamma curve through voltage division. The gamma curve may correspond to the liquid crystal display panel that is driven in a customizable manner. Thus, the gamma voltage generating apparatus may convert the grey-scale value of each pixel point into an appropriate gamma voltage based on the gamma curve.

However, since the manufacturing technologies and the liquid crystal characteristics of different manufacturers of liquid crystal display panel are different, the gamma voltages and the gamma curve that is presented suitable for the liquid crystal display panels of different manufacturers may not be necessarily the same. Thus, to satisfy the liquid crystal characteristics of different manufacturers, the gamma voltage generating apparatuses having different layouts are required in correspondence to the liquid crystal display panels of different manufacturers. An issue of manufacturing costs and an inventory issue thus occur.

### SUMMARY OF THE INVENTION

Accordingly, the invention provides a gamma voltage generating apparatus and a method for generating a gamma voltage. The gamma voltage generating apparatus may selectively changes a reference voltage and an endpoint coupled with a resistor series based on a control signal. The gamma voltage of the gamma voltage generating apparatus may present gamma curves respectively meeting the requirement of panels of different manufacturers based on an external selecting signal. Thus, the gamma voltage generating apparatus of the invention may respectively present a plurality of gamma voltages suitable for the panels of different manufacturers without modifying the hardware. In addition, it does not require using different layouts for different panels in the manufacturing process. Therefore, the manufacturing costs and the inventory issue of the liquid crystal drivers may be reduced.

The invention provides a gamma voltage generating apparatus. The gamma voltage generating apparatus includes a plurality of digital-to-analog converter units, a resistor series, and a plurality of selecting units. The plurality of digital-to-analog converter units generate a plurality of curve reference voltages. The resistor series include a plurality of resistors connected with each other in series to provide a plurality of endpoints. In addition, a part of the endpoints are set as a plurality of curve turning intervals. Each of the selecting units respectively corresponds to each of the digital-to-analog converter units and each of the curve turning intervals. Each of the selecting units selectively provides each of the curve reference voltages to one of the endpoints in a corresponding of the curve turning intervals.

In an embodiment of the invention, each of the selecting units includes at least two switches. A first end of each of the switches is connected to the digital-to-analog converter unit corresponding to the selecting unit, and a second end of each of the switches is respectively connected to each of the endpoints in the curve turning interval corresponding to the selecting unit.

In an embodiment of the invention, each of the digital-to-analog converter unit includes a voltage selector and a buffer. The voltage selector receives a reference voltage and generates a corresponding curve reference voltage based on a reference voltage control signal. The buffer is disposed between an output end of the voltage selector and a first end of a corresponding selecting unit.

In an embodiment of the invention, the selecting unit is disposed in the buffer of each of the digital-to-analog converter units.

In an embodiment of the invention, the buffer includes an input stage circuit and a plurality of output stage circuits, and the input stage circuit has a plurality of output ends of input stage. Each of the selecting unit includes a plurality of switches, a plurality of input ends of each of the switches are connected to the output ends of input stage, and an output end of each of the switches is respectively connected with each corresponding of the output stage circuits. In addition, an output end of each of the output stage circuits is respectively connected to each of the endpoints in the curve turning interval.

In an embodiment of the invention, the selecting signal has N bits, and N is a positive integer. Each of the selecting units includes at most M switches, M being N power of 2, such that the gamma voltage generating apparatus presents M kinds of gamma gray-scale curves based on the selecting signal.

In an embodiment of the invention, different of the curve turning intervals have the same endpoint.

Viewing from another perspective, the invention provides a method for generating a gamma voltage adapted for a gamma generating apparatus, and the method for generating the gamma voltage includes: providing a plurality of curve reference voltages; providing a plurality of endpoints by using a resistor series including a plurality of resistors connected with each other in series; setting a part of the endpoints as a plurality of curve turning intervals; and selectively providing each of the curve reference voltages to one of the endpoints in a corresponding of the curve turning intervals.

In an embodiment of the invention, the gamma generating apparatus includes a plurality of selecting units, and each of the selecting units respectively corresponds to each of the digital-to-analog converter units and each of the curve turning intervals. Each of the selecting units selectively provides each of the curve reference voltages to one of the endpoints in the corresponding one of the curve turning intervals based on a selecting signal.

In an embodiment of the invention, each of the selecting units includes at least two switches. A first end of each of the switches is connected to the digital-to-analog converter unit corresponding to the selecting unit, and a second end of each of the switches being respectively connected to each of the endpoints in the curve turning interval corresponding to the selecting unit.

Based on the above, in the gamma voltage generating apparatus of the invention, the selecting unit is disposed between the digital-to-analog converter unit and the resistor series that generate the gamma voltage. The selecting unit may change the endpoint (turning point of the gamma curve) of the resistor series that receives the curve reference voltage based on the selecting signal, so as to modify the gamma curve presented by the gamma voltage. Thus, the gamma voltage generating apparatus of the invention is capable of presenting gamma curves that meet the requirement of the liquid crystal display panels of different manufactures without the need of modifying the layout of the gamma voltage generating apparatus. Thus, the manufacturing costs and the inventory issue of the liquid crystal driver are reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a gamma voltage generating apparatus according to an embodiment of the invention.

FIG. 2A is a schematic view illustrating a digital-to-analog converter unit and a selecting unit according to an embodiment of the invention.

FIG. 2B is a curve view illustrating gamma curves according to an embodiment of the invention.

FIG. 3 is a schematic view illustrating a gamma voltage generating apparatus according to an embodiment of the invention.

FIG. 4 is a schematic view illustrating a digital-to-analog converter unit according to an embodiment of the invention.

FIG. 5 is a flowchart illustrating a method for generating a gamma voltage according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

To reduce the manufacturing costs of liquid crystal drivers and solve the inventory issue, embodiments of the invention provide a gamma voltage generating apparatus and a method for generating a gamma voltage. Namely, the gamma voltage generating apparatus according to an embodiment of the invention is disposed with a plurality of selecting units between a digital-to-analog converter unit and a resistor series generating a gamma voltage, such that a reference voltage generated by the digital-to-analog converter unit may be selectively coupled to a part of endpoints in a corresponding curve turning interval through the selecting units. In this way, the gamma voltage may respectively present gamma curves that meet characteristics of panels of different manufacturers, so as to overcome the issue of manufacturing costs and the inventory issue in the manufacturing process of the liquid crystal drivers.

Technical contents, characteristics, and effects regarding the embodiments of the invention are described below in detail with reference to the drawings. In addition, whenever possible, identical or similar reference numbers stand for identical or similar elements in the drawings and the embodiments.

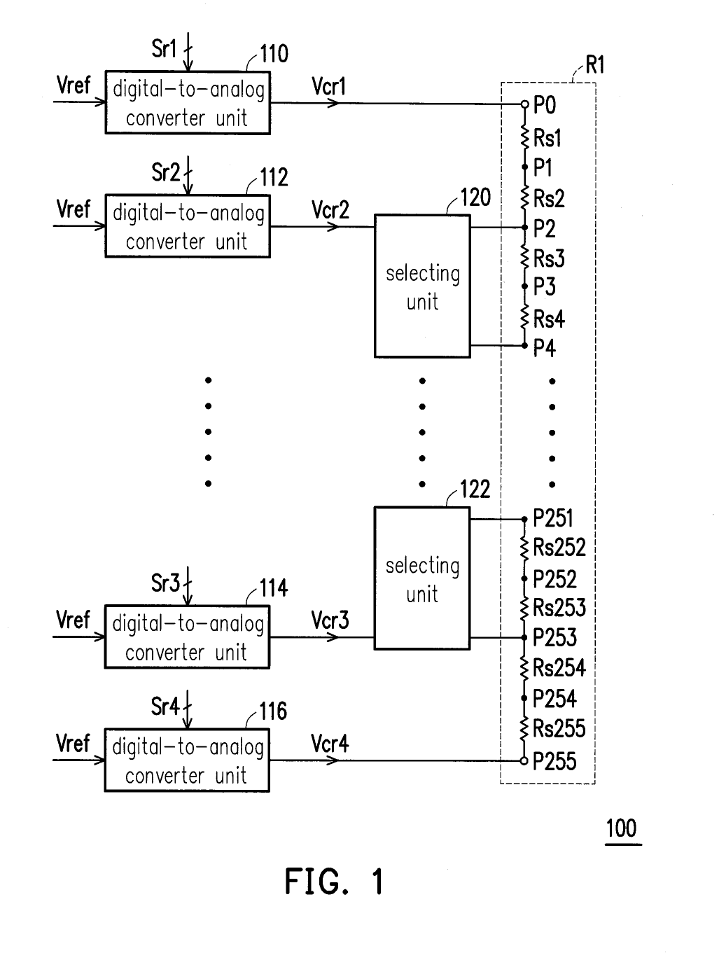

FIG. 1 is a schematic view illustrating a gamma voltage generating apparatus 100 according to an embodiment of the invention. Referring to FIG. 1, the gamma voltage generating apparatus 100 includes a plurality of digital-to-analog converter units (e.g. digital-to-analog converter units 110, 112, 114, and 116), a plurality of selecting units (e.g. selecting units 120 and 122), and a resistor series R1. The resistor series R1 are formed by a plurality of resistors connected to each other in series. Correspondingly, the resistor series R1 have a plurality of endpoints. In this embodiment, the resistor series R1 include 255 resistors Rs1 to Rs255, and 256 endpoints P0 to P255. The endpoints P0 to P255 are endpoints of the resistors Rs1 to Rs255. The gamma voltage generating apparatus 100 uses the digital-to-analog converter units 110, 112, 114, and 116 to covert a reference voltage Vref that is received, and may generate gamma voltages V0 to V255 corresponding to 256 gray-scale values at the endpoints P0 to P255. It should be noted that although the embodiment is described with the gamma voltage generating apparatus 100 including four digital-to-analog converter units 110, 112, 114, and 116, two selecting units 120 and 122, 255 resistors Rs1 to Rs255, and 256 endpoints P0 to P255, a number of each of the elements in the invention is not limited thereto.

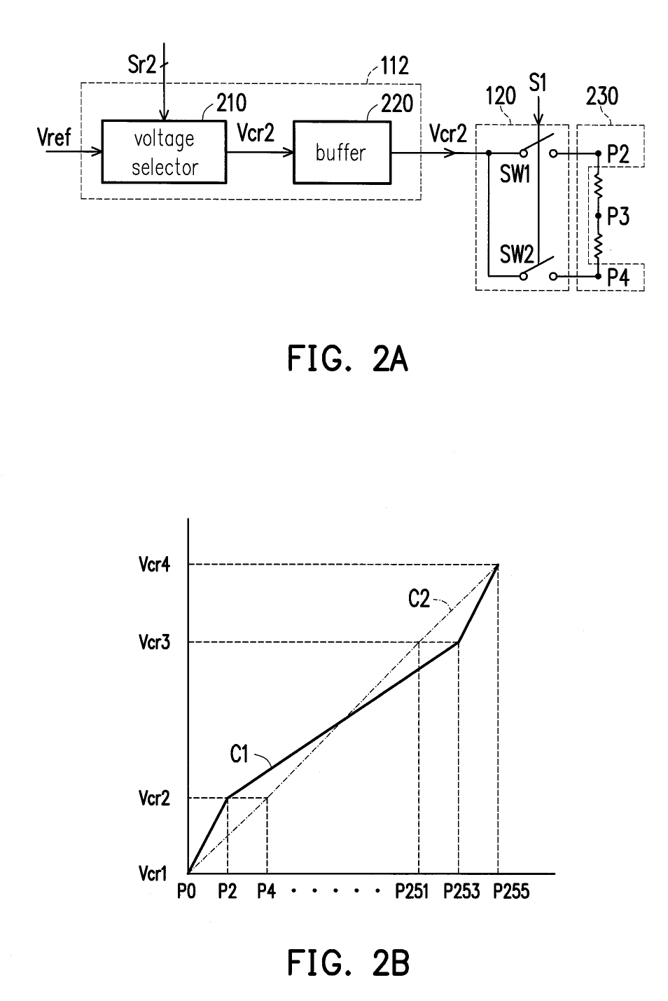

FIG. 2A is a schematic view illustrating the digital-to-analog converter unit 122 and the selecting unit 120 according to an embodiment of the invention. The digital-to-analog converter unit 122 includes a voltage selector 210 and a buffer 220. The selecting unit 120 includes two switches SW1 and SW2. The voltage selector 210 receives the reference voltage Vref and generates a corresponding curve reference voltage Vcr2 based on a digitized reference voltage control signal Sr2. More specifically, the voltage selector 210 may divide the reference voltage Vref into 2^{P} values based on the reference voltage control signal Sr2 having P bits (P is a positive integer), and choose one of the values as the curve reference voltage Vcr2. The buffer 220 is an OP direct current buffer with a negative feedback, which is capable of transmitting the curve reference voltage Vcr2 to the selecting unit 120. After receiving the curve reference voltage Vcr2, the selecting unit 120 may control the switches SW1 and SW2 based on a selecting signal S1, and couple the curve reference voltage Vcr2 to the endpoint P2 or endpoint P4. In addition, the endpoints P2 and P4 are set to be a curve turning interval 230 corresponding to the selecting unit 120.

To more specifically describe the invention, an operation of the gamma voltage generating apparatus 100 according to an embodiment of the invention, as shown in FIG. 1, is described with reference to FIG. 2A.

Referring to FIGS. 1 and 2A simultaneously, it should be noted at the outset that internal structures of the digital-to-analog converter units 110, 114, and 116 as well as the selecting unit 122 are considered to be the same as internal structures of the digital-to-analog converter unit 122 and the selecting unit 120. In FIG. 1, the digital-to-analog converter units 110, 112, 114, and 116 respectively convert the reference voltage Vref into curve reference voltages Vcr1 to Vcr4 based on reference voltage control signals Sr1 to Sr4. The curve reference voltages Vcr1 and Vcr4 are respectively coupled to the endpoints P0 and P255, whereas the curve reference voltages Vcr2 and Vcr3 are respectively coupled to the selecting units 120 and 122. The selecting unit 120 selectively couples the curve reference voltage Vcr2 to the endpoint P2 or P4 coupled with the selecting unit 120 based on the selecting signal S1. The selecting unit 122 also couples the curve reference voltage Vcr3 to the endpoint P253 or P251 coupled with the selecting unit 122 based on the selecting signal S1. In other words, the curve turning interval 230 that corresponds to the selecting unit 120 is the endpoints P2 and P4, while a curve turning interval that corresponds to the selecting unit 120 is the endpoints P251 and P253. In addition, four of the endpoints P0 to P255 are coupled with the curve reference voltages Vcr1 to Vcr4, and voltages at other endpoints are generated by voltage division of the resistor series. It should be noted that in the embodiment of the invention, a curve slope of a gamma curve C generated by the gamma voltage generating apparatus 100 may be determined by the four endpoints coupled with the curve reference voltages Vcr1 to Vcr4. In other words, the gamma curve C is turned at the four endpoints. Thus, in this embodiment, the four endpoints coupled with the curve reference voltages Vcr1 to Vcr4 may also be considered as curve turning points of the gamma curve C, and the endpoints P2 and P4 coupled with the curve reference voltage Vcr2 may be set as curve turning endpoints of the selecting unit 120, and the endpoints P251 and P253 coupled with the curve reference voltage Vcr3 may be set as curve turning endpoints of the selecting unit 122.

In the following, an operation for the gamma voltage generating apparatus 100 according to an embodiment of the invention to generate two kinds of gamma curves C1 and C2 in correspondence with liquid crystal display panels with different characteristics is described. FIG. 2B is a view illustrating the gamma curves C1 and C2 according to an embodiment of the invention. Referring to FIGS. 1 and 2B simultaneously, in FIG. 1, the selecting units 120 and 122 are controlled by the selecting signal S1. In this embodiment, the selecting signal S1 may be a one-bit digital signal. When the selecting signal S1 is enabled (Logic 1), the selecting unit 120 couples the curve reference voltage Vcr2 to the endpoint 2, and the selecting unit 122 couples the curve reference voltage Vcr3 to endpoint P253. Here, the endpoints P0, P2, P253, and P255 are the curve turning points that determine the curve slope of the gamma curve, and the gamma voltage generating apparatus 100 may present the gamma curve C1 (as shown in FIG. 2B).

In addition, when the selecting signal S1 is disabled (Logic 0), the selecting unit 120 couples the reference voltage Vcr2 to the endpoint P4, and the selecting unit 122 couples the reference voltage Vr3 to the endpoint P251. Here, the endpoints P0, P4, P251, and P255 are the curve turning points that determine the curve slope of the gamma curve, and the gamma voltage generating apparatus 100 may present the gamma curve C2 (as shown in FIG. 2B). Thus, the gamma voltage generating apparatus 100 according to an embodiment of the invention is capable of generating the two kinds of gamma curves C1 and C2 in correspondence with the characteristics of different panels.

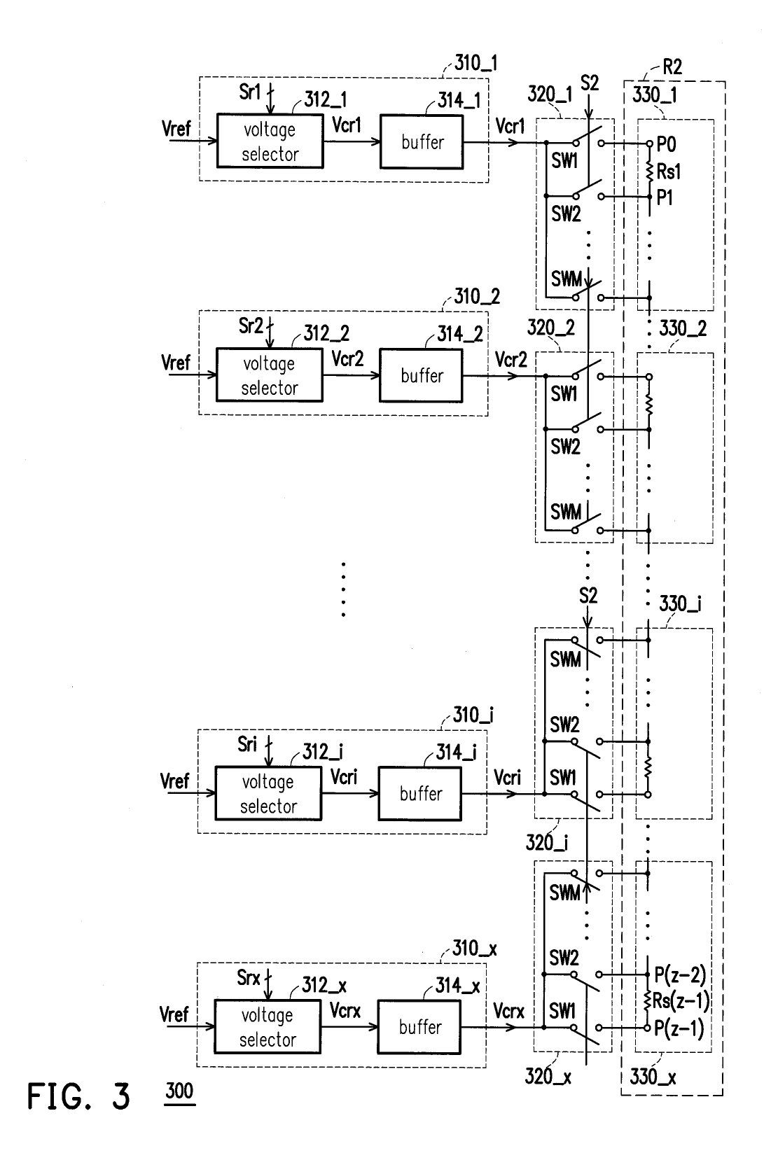

In the embodiments of the invention, no limitation is imposed on the numbers of the endpoints of the resistor series R1 and the endpoints coupled to the digital-to-analog converter units or coupled to the selecting units. Therefore, the gamma voltage generating apparatus 100 of FIG. 1 may be further elaborated to form a gamma voltage generating apparatus 300 of FIG. 3. FIG. 3 is a schematic view illustrating the gamma voltage generating apparatus 300 according to an embodiment of the invention. The gamma voltage generating apparatus 300 includes x (x is a positive integer) digital-to-analog converter units 310_1 to 310_{—}x, x selecting units 320_1 to 320_{—}x, and a resistor series R2. Each digital-to-analog converter unit 310_{—}i (i may be 1 to x) includes a voltage selector 312i and a buffer 314i, operations of the voltage selector 312_{—}i and the buffer 314_{—}i are already described in the embodiment above, so no further details in this respect will be reiterated below. The resistor series R2 include z endpoints P0 to P(z−1) (z is a positive integer larger than 1) and z−1 resistors Rs1 to Rs (z−1). In FIG. 3, the x digital-to-analog converter units 310_1 to 310_{—}x generate x curve reference voltages Vcr1 to Vcrx and transmit the x curve reference voltages Vcr1 to Vcrx to the corresponding selecting units 320_1 to 320_{—}x. Each of the selecting units 320_{—}i controls M switches SW1 to SWM (M equals to 2^{N}) according to a N-bit (N is a positive integer) selecting signal S2, and a plurality of endpoints in the resistor series R2 that are coupled to the switches SW1 to SWM of each of the selecting units 320_{—}i are set to be curve turning intervals 330_{—}i respectively corresponding to the selecting units 320_{—}i. In other words, based on the selecting signal S2, the selecting units 320_1 to 320_{—}x may selectively couple the curve reference voltages Vcr1 to Vcrx with one of the endpoints of the curve turning intervals 330_1 to 330_{—}x corresponding to the selecting units 320_1 to 320_{—}x. Thus, the gamma voltage generating apparatus 300 may have M kinds of gamma gray-scale curves according to the selecting signal S2.

In addition, although in this embodiment of the invention, each of the digital-to-analog converter units 310_{—}i is coupled with a corresponding selecting unit 320i, the embodiments of the invention are not limited thereto. The digital-to-analog converter units 310_{—}i may also be directly coupled with the resistor series R2, and the selecting units may be disposed on output stage circuits of the digital-to-analog converter units 310_{—}i. In addition, the embodiments of the invention do not intend to impose a limitation on the endpoints of the resistor series R2 coupled to the digital-to-analog converter units 310i or coupled to the selecting units 320_{—}i. However, if the endpoints at upper and lower ends of the resistor series R2 (e.g. the endpoint P0 and the endpoint P(z−1)) are not coupled with the digital-to-analog converter units 310_{—}i or the selecting units 320_{—}i, the endpoints P0 and P(z−1) of the resistor series R2 may be respectively coupled with a voltage VDD and a voltage VSS to provide the endpoints with voltages corresponding to each other. In this way, the resistor series R2 generate a corresponding gamma voltage at each of the endpoints by voltage division of the resistor series.

It should be noted in particular that the curve turning intervals 330_{—}i of different of the selecting units 320_{—}i may have the same endpoints. In other words, the same endpoint may be included in different of curve turning intervals 330_{—}i. In addition, the endpoint may be coupled to different of the curve reference voltages Vcr1 to Vcrx by the different selecting units 320i according to the selecting signal S2. Thus, the gamma voltage generating apparatus 300 may present gamma gray-scale curves adapted for more kinds of characteristics of panels, making the gamma voltage generating apparatus 300 more generally applicable.

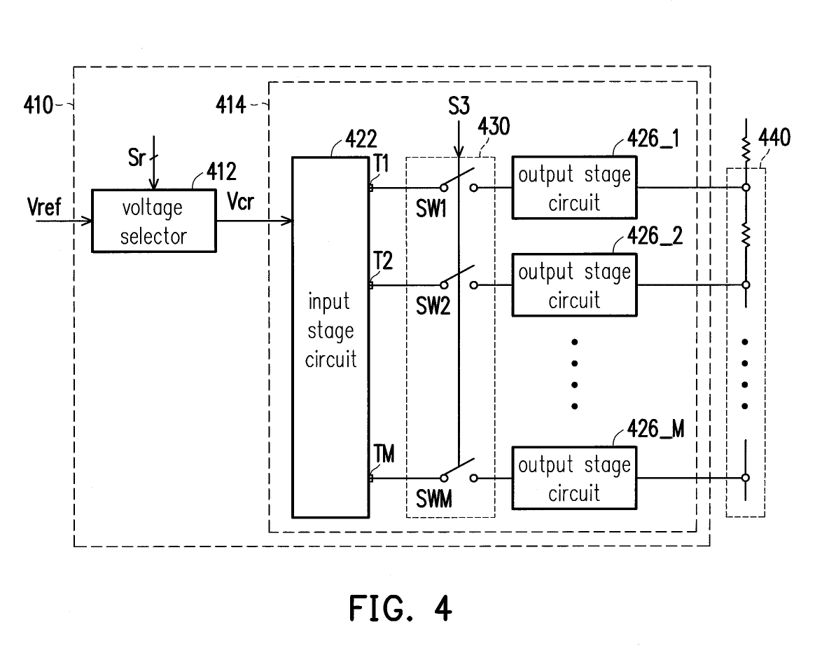

In practical use, the selecting units 320i in FIG. 3 may be integrated into the buffers 314_{—}i, such that internal resistances of the selecting units 320_{—}i do not influence a cross voltage value of each of the resistors Rs1 to Rs(z−1) of the resistor series R2, thereby reducing circuit design errors. Further description in this respect is provided below with reference to FIG. 4.

FIG. 4 is a schematic view illustrating a digital-to-analog converter unit 410 according to another embodiment of the invention. Referring to FIG. 4, the digital-to-analog converter unit 410 includes a voltage selector 412 and a buffer 414. A part of an operation of the digital-to-analog converter unit 410 is already described in the embodiments above, so the similar part will not be reiterated below. What differs from the embodiment above is that, in this embodiment, the buffer 414 includes an input stage circuit 422 and M output stage circuits 426_1 to 426_M. In addition, the input stage circuit 422 has M output ends T1 to TM of the input stage. The output stage circuit 426 is a CMOS inverter, for example. A selecting unit 430 is coupled between the input stage circuit 422 and the M output stage circuits 426, and includes the M switches SW1 to SWM. More specifically, an output end of each of the M switches SW1 to SWM of the selecting unit 430 is respectively coupled with a corresponding of the output ends T1 to TM of the input stage. In addition, an output end of each of the M switches SW1 to SWM is respectively coupled with a corresponding of the output stage circuits 426_1 to 426_M. Output ends of the M output stage circuits 426_1 to 426_M are coupled with M endpoints on the resistor series R2. The M endpoints are configured to correspond to a curve turning interval 440 of the selecting unit 430. Thus, in FIG. 4, when the voltage selector 412 transmits the corresponding curve reference voltage Vcr into the buffer 414, the input stage circuit 422 may control the M switches SW1 to SWM through the selecting unit 430 based on a N-bit selecting signal S3 (N is a positive integer, and M equals to 2^{N}). Accordingly, the curve reference voltage Vcr is transmitted to a corresponding output stage circuit 426_{—}j (j may be 1 to M), and the curve reference voltage Vcr is coupled to one of the endpoints of the curve turning interval 440. If the digital-to-analog converter unit 410 replaces the digital-to-analog converter unit 310_{—}i and the selecting unit 320_{—}i, the gamma voltage generating apparatus 300 may still present M kinds of gamma gray-scale curves based on the selecting signal S3.

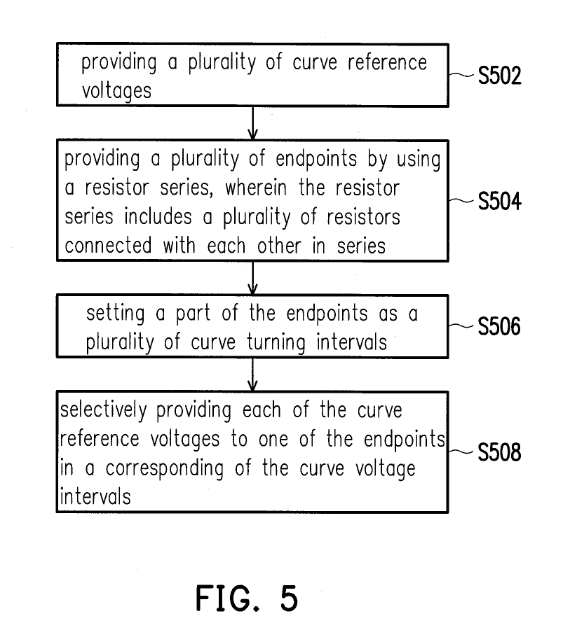

A method for generating a gamma voltage is also provided according to an embodiment of the invention. The method for generating the gamma voltage is suitable for the gamma voltage generating apparatus 300. Steps of the method are described with reference to FIG. 5.

FIG. 5 is a flowchart illustrating a method for generating a gamma voltage according to an embodiment of the invention. Referring to FIGS. 3 and 5 simultaneously, at Step S502, the plurality of digital-to-analog converter units 310_1 to 310_{—}x provide the plurality of curve reference voltages Vcr1 to Vcrx. More specifically, the voltage selector 312i in each of the digital-to-analog converter unit 310_{—}i divides the reference voltage Vref into 2^{P} values based on a P-bit (P is a positive integer) reference voltage control signal Sri, and then chooses one of the values as each of the curve reference voltages Vcr1 to Vcrx.

At Step S504, the gamma voltage generating apparatus 300 uses the resistor series R2 to provide the plurality of endpoints P0 to P(Z−1) (Z is a positive integer larger than 1). In addition, the resistor series R2 include the plurality of resistors Rs1 to Rs(Z−1) that are connected with each other in series. At Step S506, a part of the endpoints P0 to P(Z−1) are set as the plurality of curve turning intervals 330_1 to 330_{—}x. Furthermore, at Step S508, each of the digital-to-analog converter units 310_{—}i selectively provides each of the curve reference voltages Vcr1 to Vcrx to one of the endpoints in a corresponding of the curve turning intervals 330_{—}i by using each of the selecting units 320_{—}i. More specifically, each of the digital-to-analog converter units 310_{—}i may choose through each of the selecting units 320_{—}i based on the selecting signal S2, and selectively provide each of the curve reference voltages Vcr1 to Vcrx to one of the endpoints of the corresponding one of the curve turning intervals 330_{—}i, so as to allow the gamma voltage generating apparatus 300 to present a plurality of kinds of corresponding gamma curves.

Based on the above, according to the gamma voltage generating apparatus and the method for generating the gamma voltage of the invention, the selecting unit is disposed between the digital-to-analog converter unit and the resistor series that generate the gamma voltage. In addition, by setting the curve turning interval corresponding to each of the selecting units, the gamma voltage generating apparatus may control the selecting unit to provide the curve reference voltage to one endpoint of the curve turning interval based on the selecting signal, so as to provide a plurality of gamma curves. The gamma curves required by the liquid crystal display panels of different manufacturers are presented without the needs of using gamma voltage generating apparatuses having different layouts. Thus, the manufacturing costs and the inventory issue of the liquid crystal drivers are reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A gamma voltage generating apparatus, comprising:
a plurality of digital-to-analog converter units, generating a plurality of curve reference voltages;
a resistor series, comprising a plurality of resistors connected with each other in series to provide a plurality of endpoints, wherein a part of the endpoints are set as a plurality of curve turning intervals; and
a plurality of selecting units, each of the selecting units respectively corresponding to each of the digital-to-analog converter units and each of the curve turning intervals,
wherein each of the selecting units selectively provides each of the curve reference voltages to one of the endpoints in a corresponding of the curve turning intervals based on a selecting signal.

2. The gamma voltage generating apparatus as claimed in claim 1, wherein each of the selecting units comprises:
at least two switches, a first end of each of the switches being connected to the digital-to-analog converter unit corresponding to the selecting unit, and a second end of each of the switches being respectively connected to each of the endpoints in the curve turning interval corresponding to the selecting unit.

3. The gamma voltage generating apparatus as claimed in claim 1, wherein each of the digital-to-analog converter units comprises:
a voltage selector, receiving a reference voltage and generating a corresponding of the curve reference voltages based on a reference voltage control signal; and
a buffer, disposed between an output end of the voltage selector and a first end of a corresponding of the selecting unit.

4. The gamma voltage generating apparatus as claimed in claim 3, wherein the selecting units are disposed in the buffer of each of the digital-to-analog converter units.

5. The gamma voltage generating apparatus as claimed in claim 4, wherein the buffer comprises an input stage circuit and a plurality of output stage circuits, and wherein the input stage circuit has a plurality of output ends of input stage, and
each of the selecting units comprises:
a plurality of switches, a plurality of input ends of each of the switches being connected to the output ends of input stage, and an output end of each of the switches being respectively connected with each corresponding of the output stage circuits,
wherein an output end of each of the output stage circuits is respectively connected to each of the endpoints in the curve turning interval.

6. The gamma voltage generating apparatus as claimed in claim 1, wherein the selecting signal has N bits, N being a positive integer, and each of the selecting units comprises at most M switches, M being N power of 2, such that the gamma voltage generating apparatus presents M kinds of gamma gray-scale curves based on the selecting signal.

7. The gamma voltage generating apparatus as claimed in claim 1, wherein different of the curve turning intervals have the same endpoint.

8. A method for generating a gamma voltage adapted for a gamma voltage generating apparatus, the method comprising:
providing a plurality of curve reference voltages;
providing a plurality of endpoints by using a resistor series, wherein the resistor series comprise a plurality of resistors connected with each other in series;
setting a part of the endpoints as a plurality of curve turning intervals; and
selectively providing each of the curve reference voltages to one of the endpoints in a corresponding of the curve turning intervals based on a selecting signal.

9. The method as claimed in claim 8, wherein the curve reference voltages are provided by the digital-to-analog converter units, and the gamma voltage generating apparatus comprises:
a plurality of selecting units, each of the selecting units respectively corresponding to each of the digital-to-analog converter units and each of the curve turning intervals,
wherein each of the selecting units selectively provides each of the curve reference voltages to one of the endpoints in the corresponding one of the curve turning intervals based on a selecting signal.

10. The method as claimed in claim 9, wherein each of the selecting units comprises:
at least two switches, a first end of each of the switches being connected to the digital-to-analog converter unit corresponding to the selecting unit, and second ends of the at least two switches being respectively connected to each of the endpoints in the curve turning interval corresponding to the selecting unit.
